(19) United States
(12) Patent Application Publication
(10) Pub. No.: US 2026/0219565 A1
(43) Pub. Date: Jul. 30, 2026

(54) SURROUND-VIEW IMAGING SYSTEM WITH SIMULTANEOUS TOF AND RGB IMAGE ACQUISITION

(71) Applicant: Jabil Optics Germany GmbH, Jena (DE)

(72) Inventor: Andreas Bock, Jena (DE)

(73) Assignee: Jabil Optics Germany GmbH, Jena (DE)

(21) Appl. No.: 19/146,081

(22) PCT Filed: Feb. 15, 2023
(86) PCT No.: PCT/EP2023/053811

§ 371 Date: Jul. 7, 2025

(51) Int. Cl. G03B 37/00; G01S 17/894; H04N 23/11; H04N 23/16; H04N 23/55

(52) U.S. Cl. CPC G03B 37/00; G01S 17/894; H04N 23/11; H04N 23/16; H04N 23/55

(57) ABSTRACT

A surround-view imaging system for three dimensional imaging of a surrounding is described. An imager enables simultaneous time of flight and optical image acquisition with full sensor resolution. A first image detector and a cylindrical catadioptric lens system forms an inner volume with an entrance aperture and top and bottom surfaces Imaging light from the imager surrounding enters the inner volume by the entrance aperture, is firstly reflected towards the top surface by the bottom surface, is secondly reflected back to the bottom surface by the top surface, and leaves the inner volume towards the first image detector by a bottom aperture in the bottom surface for detecting imaging light. The imaging light spectrum comprises first and second spectral ranges, which are different. A spectral filtering element reflects only the first spectral range imaging light back to the bottom surface but transmits second spectral range imaging light.

### CROSS REFERENCE TO RELATED APPLICATION(S)

This application is a national stage 371 application of PCT/EP2023/053811, filed Feb. 15, 2023, the entire disclosure of which is hereby incorporated by reference.

### TECHNICAL FIELD

The present invention refers to a surround-view imaging system for three dimensional (3D) imaging of a surrounding of the system, and in particular to an imager for such a surround-view imaging system that enables simultaneous time of flight (TOF) and optical (RGB) image acquisition with full sensor resolution.

### BACKGROUND

For 3D imaging systems or sensors which can locate objects in a 3D surrounding of the system, there are different approaches available which are based on various technologies such as light detection and ranging (LiDAR), time of flight (TOF, direct and indirect versions), amplitude or frequency modulated illumination, structured light, etc. Such systems can typically be found in autonomous mobile robots (AMRs), industrial mobile robots (IMRs), and automated guided vehicles (AGVs) like lift trucks, forklifts, cars, drones, etc. to avoid collisions, to detect obstacles, for passenger monitoring and for observing keep-out-zones for machines and robots. Surround-view imaging systems can also be used for collaborative robotics, security and surveillance camera applications.

If the system is optics-based and an array detector (e.g., CMOS sensor, CCD sensor, array of photodiodes, . . . ) is used in order to avoid moving parts in the system, then the receiving lens, which images the surrounding onto an associated image detector, is a highly critical element. The lens must allow a high resolution over a wide field of view (FOV) in the horizontal and the vertical direction. At the same time, it should have uniform imaging properties without vignetting and a high light throughput to achieve a large coverage area.

For wide horizontal fields of view (HFOV), e.g., larger than 120 degrees, a fisheye lens can be used in the upright position. However, a conventional fisheye lens has several disadvantages, such as high incidence angles and associated coating problems. Further problems are a very wide field of view in combination with low resolution, low f-number and vignetting caused by offset illumination. These drawbacks can be avoided by using a catadioptric lens system in which mirrors and lenses are combined to form the image.

A surround-view image can be generated by using a wide-angle lens (e.g., a fisheye lens or rectilinear lens) as first lens of a lens system in a corresponding imaging system. Wide-angle lenses can have an angle of view (AOV), e.g., the maximum zenithal angle range in a vertical direction for which a lens can provide an image, of more than 180°. Lenses with an AOV of more than 180° are called ultra wide-angle lenses. Angles of view up to around 300° can be achieved. In a typical axially symmetric imaging system, the imageable azimuthal angle range, e.g., in a horizontal direction, is typically 360°, which allows surround-view in the azimuthal direction. Therefore, with an ultra wide-angle lens solid angles 2 of up to around 3× steradian can be imaged. Wide-angle lenses typically show a strong curvilinear barrel distortion, which can to some degree optically corrected in rectilinear lenses. An optical barrel distortion correction can also be included in the design of an associated lens system. Lens systems with an AOV larger than 180° are accordingly called ultra wide-angle lens systems.

In order to further improve the accuracy as well as the reliability of 3D imaging, different technologies may be combined in a single surround-view imaging system. In particular, the combination of advanced TOF techniques with RGB image acquisition has proven to be especially beneficial. In such combined imaging systems, the images captured with different technologies must have a substantial overlap to allow fast and efficient image processing for subsequent analysis of combined image data.

Therefore, such surround-view imaging systems typically apply a single image detector which enables to detect both signals from imaging light which is received by a common beam path. The acquired images then belong to a common FOV. In such kind of dual-mode detectors, each pixel typically has a set of four individual sub-pixels, namely subpixels specifically sensitive to red, green, blue and infrared light. However, such detectors can only provide a reduced resolution for the TOF and RGB data, because the TOF and RGB subpixels of the pixels are located side by side which limits the resolution the optical system (see FIG. 1).

An alternative approach which can use the full resolution of a detector is a so-called side-by-side arrangement of individual detection systems. However, these detection systems must be arranged such that they also belong to a common FOV, which means that they have to be aligned one after another at a common plane, e.g., the horizonal plane. However, with such a side-by-side arrangement of dedicated TOF and RGB detectors, a full 360° horizontal FOV cannot be realized because the FOV of the rear detector will partly be blocked by the front detector. Furthermore, image information still needs to be aligned and preprocessed in software later, due to the slightly different perspectives on a scene in the surrounding of the system (see FIG. 2).

The objective problem of the invention is thus related to the problem of acquiring simultaneous TOF and RGB data in full detector resolution on a complete 360° HFOV. Therefore, a surround-view imaging system shall be provided that avoids or at least reduces the problems of combined TOF/RGB imaging systems in the prior art.

### SUMMARY

The invention solves the objective problem by providing an imager for a surround-view imaging system as defined in claim 1. Further provided is a surround-view imaging system comprising an imager according to the present invention.

An imager for a surround-view imaging system according to the present invention comprises a first image detector and a cylindrical catadioptric lens system forming an inner volume with an entrance aperture, a top surface and a bottom surface. In a field of view of the imager, imaging light from a surrounding of the imager enters the inner volume by the entrance aperture, is firstly reflected towards the top surface by the bottom surface, is secondly reflected back to the bottom surface by the top surface, and leaves the inner volume towards the first image detector by a bottom aperture in the bottom surface for detecting imaging light. The spectrum of the imaging light comprises a first spectral range and a second spectral range different from the first spectral range. The top surface comprises a spectral filtering element which reflects only the imaging light of the first spectral range back to the bottom surface but transmits imaging light of the second spectral range.

Preferably, the imager further comprises a second image detector for detecting the transmitted imaging light. Preferably, the imager further comprises a first optical system to project an image of the environment in the first spectral range on the first image detector. Preferably, the imager further comprises a second optical system to project an image of the environment in the second spectral range on the second image detector. In a particularly preferred embodiment, the first image detector is a detector for the visible spectral range (RGB detector) and the second image detector is a TOF detector, or the first image detector is a TOF detector and the second image detector is a detector for the visible spectral range (RGB detector).

An imager is to be understood as a device which is able to receive, focus and detect imaging light entering the imager from a surrounding of the imager. It therefore typically comprises at least an (preferably ring-shaped circumferential) 360° entrance aperture adjacent to the surrounding, a lens or other optical element to generate an image of the surrounding and an associated image detector to detect the generated image of the surrounding for further processing. Since the generation of the image is the far most critical aspect for ensuring a good image quality, instead of using a single lens or optical element, lens systems (or optical component systems in general) for the correction of occurring aberrations may be used in an imager. An imager can be a device which uses ambient light for imaging (e.g., 3D visible or infrared light) or may be specifically adapted to image reflected light from an illumination light source or illuminator (illumination light) as imaging light (e.g., flash LIDAR).

In combined ToF/RGB imaging systems, the spectrum of the imaging light typically comprises a first and a second spectral range. In particular, the first spectral range may refer to the visible (VIS) spectrum of light (or at least one part of said spectral range) and the second spectral range may refer to the infrared (IR/SWIR) spectrum of light (or at least one part of said spectral range), or vice versa. In particular, the first spectral range may belong to RGB imaging and the second spectral range may belong to a TOF imaging. The two spectral ranges must be separated to avoid any signal interferences between the two systems.

The top surface of the catadioptric lens system comprises a spectral filtering element which reflects only the imaging light from the first spectral range back to the bottom surface but transmits imaging light of the second spectral range. Thus, a kind of beam splitter is included in the beam path that allows to generated images of the environment with individual spectra at different detectors. Therefore, the two images can belong to a common FOV and the two detectors are not blocking one another.

It is the main idea of the present invention to use a custom lens for simultaneous RGB and TOF data acquisition. The reflected light from an actively or passively illuminated scene can be collected on a 360° HFOV. The light may be reflected on a first mirror to a second optical element. This optical element may be a transmitter for the VIS spectrum (RGB) and a reflector for the NIR/SWIR spectrum (TOF). For example, a dedicated RGB detector may collect the VIS photons above the first mirror. A dedicated TOF detector may collect the NIR/SWIR photons in a region below of the first mirror. The detectors can be individually optimized by taking resolution, sensor size, pixel size and interfaces, and performance into account. The FOV and other parameters of the TOF and RGB detectors can be optimally adapted to the respective requirements of a specific application. Both detectors share a common beam path and belong to an identical 360° HFOV, which can be observed without any blind spots and the full scene surrounding the system can be captured on 360° HFOV and a fully adjustable vertical FOV (VFoV). A preprocessing of the data is not required since the information is already match due to the identical FOV.

Preferably, the cylindrical catadioptric lens system is formed by a cylindrically shaped monolithic catadioptric lens having a corpus filling the inner volume and having a mantle including the entrance aperture, the top surface and the bottom surface. Optionally, the cylindrical catadioptric lens system may be based on an arrangement of individual optical components such as mirrors, beam splitters and deflectors. The inner volume may remain free in such cases.

For a preferred embodiment of a cylindrically shaped monolithic catadioptric lens, the imaging light is firstly reflected by a circumferential first aspheric lens region arranged around a center of the bottom surface, is secondly reflected by a second aspheric lens region arranged at a center of the top surface, and leaves the inner volume towards the first image detector by a third aspheric lens region at the center of the bottom surface.

The imaging light may thus enter the monolithic catadioptric lens via its cylindrical side surface and may then successively reflected by two aspherical mirror (or mirrored) surfaces. The first aspherical mirror surface interacting with said light can be a Forbes asphere (G. W. Forbes, “Shape specification for axially symmetric optical surfaces,” Opt. Express 15 (8), 5218-5226 (2007)), whereas the other mirror surface can exhibit a standard aspherical description. As a result of using a Forbes asphere, an improved optical performance can be obtained for the above-mentioned surface.

The imaging light may leave the inner volume of the monolithic catadioptric lens via the third aspherical surface (e.g., standard asphere), which adds an additional degree of freedom to the ability to correct optical aberrations. Further benefits of a monolithic design compared to classical fisheye lenses are the realization of moderate surface tangent slopes and angles of incidence, as well as a smaller element diameter. Compared to a solution with single mirror elements, a monolithic lens design offers advantages for simple system assembly, and can be manufactured more precisely and with lower tolerances.

In contrast to standard fisheye lenses, a catadioptric lens design limits the field of view of the imager in the vertical direction in order to avoid saturation and overexposure of an associated image detector. In particular, the system could have a horizontal and vertical field of view of 360 degrees×60 degrees. With a catadioptric lens in the upright position, the 60 degrees may be divided, for example, into 45 degrees upwards and 15 degrees downwards from the horizontal plane. However, with such lenses even wider horizontal and vertical fields of view of up to 360 degrees×120 degrees can also be realized. By limiting the field of view to required angle ranges, imaging light only from relevant regions of the surrounding may enter the lens and the imager, respectively. A smaller vertical field of view thus reduces the possibility of detector saturation from accidentally captured ambient and scattered light. In particular, for ambient light which is reflected under flat angles of incidence (e.g., a bright reflection of evening sunlight on a wet road), an entry into the imager can be avoided.

For example, a monolithic catadioptric lens may be designed to have an f-number of 1.5 over the whole field of view without vignetting. Preferred f-numbers are in a range between 1.2 and 1.8, more preferably in a range between 1.4 and 1.6. Due to the compact monolithic design of the lens, aberrations can be effectively corrected already during production of the lens and without requiring a complex and error-prone post-production assembling process. This also ensures a good long-term stability of the imager and makes the lens relatively independent of variations of external environmental parameters like temperature or humidity.

As the monolith already comprises 3 aspherical surfaces, the rest of the optical system can be managed with simple spherical lenses only, while still ensuring a good optical performance (e.g., MTF, distortion, etc.) at moderate costs. The distortion can be chosen so that the vertical and horizontal resolution at an image detector with quadratic pixels is (at least approximately) the same. Furthermore, distortions may be specifically generated to obtain a demanded resolution in specific ROI. However, to further improve the optical properties of the lens, also the region of the mantle where the imaging light from a surrounding of the imager enters the corpus may comprise an additional aspherical shape. In this case, four aspherical surfaces may be present on the lens in order to get a higher performance and/or lower or improved distortion properties.

Preferably, the entrance aperture of the imager comprises an antireflection coating configured for transmitting the full spectrum of the imaging light. Preferably, the spectral filtering element comprises a dielectric layer or grating.

Preferably, the first image detector and the second image detector are arranged opposite to one another with their active surface parallelly aligned along a vertical axis of the imager.

In a preferred embodiment, the image detectors may have an active detection region which is adapted to the image size or a specifically defined region of interest (ROI). As the central region of the image, which may correspond to zenithal angles outside the effective FOV of the imager, may not be relevant for imaging, these regions of the image detector can be completely omitted or neglected from image readout or by a selective mapping with an effective active detector surface. This has the advantage that otherwise passive regions of the image detector cannot be saturated by accidentally captured ambient and scattered light. Furthermore, due to the fact that no readout of insignificant detector regions has to be performed, the effective frame rates of a specific type of detector may be increased for specific detector configurations. Through higher frame rates, the accumulation of optically induced charge carriers in the individual pixels of a detector can be reduced such that the signal-to-noise ratio (SNR) of the detector can be optimized for image detection over a wide dynamic range without using high dynamic range (HDR) techniques.

Further preferred embodiments of the invention result from features mentioned in the dependent claims.

The various embodiments and aspects of the invention mentioned in this application can be combined with each other to advantage, unless otherwise specified in the particular case.

### BRIEF DESCRIPTION OF THE DRAWINGS

In the following, the invention will be described in further detail by figures. The examples given are adapted to describe the invention. The figures show:

FIG. 1 a schematic illustration of pixel array in a prior art dual-mode detector for simultaneous TOF and RGB imaging;

FIG. 2 a schematic illustration of prior art side-by-side configurations of two separate detectors for simultaneous TOF and RGB imaging;

FIG. 3 a schematic illustration of an exemplarily embodiment of an imager of the present invention; and

FIG. 4 schematic illustrations for using different alignments of the images on the detectors to optimize image resolution and FOV of the imager of a surround-view imaging system.

### DETAILED DESCRIPTION

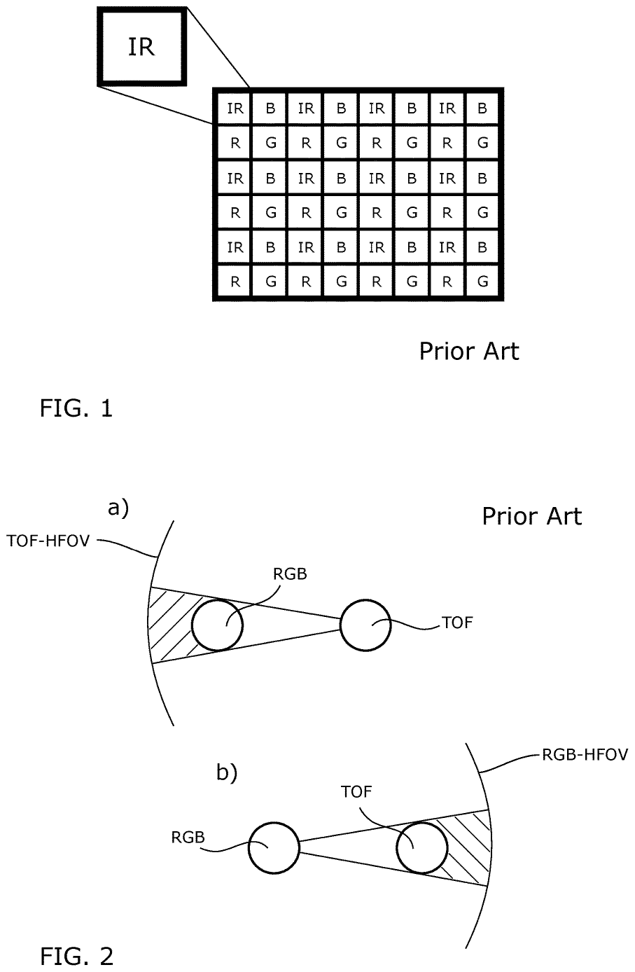

FIG. 1 shows a schematic illustration of pixel array in a prior art dual-mode detector for simultaneous TOF and RGB imaging. The combination of TOF and RGB pixels on a sensor level reduces the resolution and impair the image quality. A 640×480 pixel sensor (e.g., Panasonic GC1N) delivers only 320×240 TOF resolution, which is by far not enough for 360° HFOV imaging where a much higher resolution is a necessary requirement.

FIG. 2 shows a schematic illustration of prior art side-by-side configurations of two separate detectors for simultaneous TOF and RGB imaging. However, with such a side-by-side arrangement of dedicated TOF and RGB detectors, a full 360° horizontal FOV cannot be realized because the FOV of the rear detector will partly be blocked by the front detector. Furthermore, image information still needs to be aligned and preprocessed in software later, due to the slightly different perspectives on a scene in the surrounding of the system.

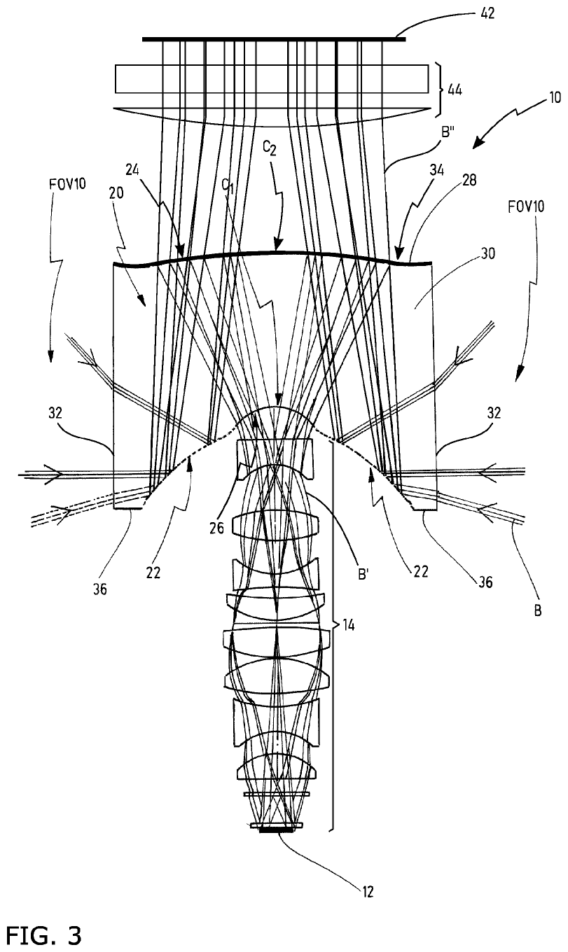

FIG. 3 shows a schematic illustration of an exemplarily embodiment of an imager 10 of the present invention. The imager 10 comprises a first image detector 12 and a cylindrical catadioptric lens system forming an inner volume 30 with an entrance aperture 32, a top surface 34 and a bottom surface 36. In a field of view of the imager FOV10, imaging light B from a surrounding of the imager 10 enters the inner volume 30 by the entrance aperture 32, is firstly reflected towards the top surface 34 by the bottom surface 36, is secondly reflected back to the bottom surface 36 by the top surface 34, and leaves the inner volume 30 towards the first image detector 12 by a bottom aperture in the bottom surface 36 for detecting imaging light B. The spectrum of the imaging light B comprises a first spectral range and a second spectral range different from the first spectral range. The top surface 34 comprises a spectral filtering element 28 which reflects only the imaging light B of the first spectral range back to the bottom surface 36 but transmits imaging light B of the second spectral range.

The cylindrical catadioptric lens system may preferably be formed by a cylindrically shaped monolithic catadioptric lens 20 having a corpus filling the inner volume 30, and having a mantle including the entrance aperture 32, the top surface 34 and the bottom surface 36. In this case, the imaging light B may be firstly reflected by a circumferential first aspheric lens region 22 arranged around a center C1 of the bottom surface 36, may be secondly reflected by a second aspheric lens region 24 arranged at a center C2 of the top surface 34, and leaves the inner volume 30 towards the first image detector 12 by a third aspheric lens region 26 at the center C1 of the bottom surface 36.

A corresponding catadioptric lens 20 may thus comprise four optically active surfaces on which imaging light B becomes redirected while propagating through the corpus 30 of the monolith. The mantle 32 and the third aspheric lens region 26 should be highly transparent for the imaging light B. At these surfaces, imaging light is redirected by diffraction when the refractive index of the catadioptric lens 20 differs from the refractive index of the surrounding. Preferably, the catadioptric lens 20 is made from a plastic material with high refractive index (transparent in the relevant spectral range of the imaging light B) like acrylic, polystyrene, polycarbonate, cyclic olefin polymer (COP) or composites made from these materials. However, any material which is transparent in the relevant spectral range of the imaging light B can be used.

At the first aspheric lens region 22 and second aspheric lens region 24, the imaging light B may be redirected by reflection. This means that at these regions the respective surfaces of the corpus 30 may serve as mirrors for the incident imaging light B. Preferably, the mirrors can be produced by coating the corresponding surfaces with a metal or dielectric layer (mirrored surfaces). A dielectric layer may be a dielectric stack designed to provide high reflection in the relevant spectral range of the imaging light B. The use of reflective surfaces generally prevents the occurrence of scattered light in the catadioptric lens 20, which could accidentally enter subsequent sections of the imager 10. In other words, a catadioptric lens 20 is a stable and compact optical component, which is cheap and easy to produce and which reduces the risk of saturation and overexposure of an associated image detector 12 by avoiding the occurrence of stray light inside the catadioptric lens 20.

The shown imager 10 further comprises a first optical system 14 to project an image of the environment in the first spectral range on the first image detector 12. It further comprises a second image detector 42 for detecting the transmitted imaging light B and a second optical system 44 to project an image of the environment in the second spectral range on the second image detector 42. The first image detector 12 and the second image detector 42 are arranged opposite to one another with their active surface parallelly aligned along a vertical axis of the imager 10.

The first optical systems is exemplarily shown as a lens stack between the catadioptric lens 20 and the first image detector 12. In particular, the shown lens stack comprises eight spherical lenses for further image projection. As the shown monolithic lens 20 comprises three aspherical surfaces, the rest of the optical system can be managed with standard spherical lenses only, while still ensuring a good optical performance (i.e., MTF, distortion, etc.) at moderate costs. The imager 10 can further include additional bandpass filters, which may preferably be arranged between the optical systems 14, 44 and a respective image detector 12, 42. An additional bandpass filter can cut off spectral components of the illumination light which are not relevant for image generation or which would otherwise lead to saturation and overexposure of the first image detector 12. The second optical systems 44 may be the same or at least a comparable to the first optical system 14. Since the two optical paths are quite similar, the optical requirements for imaging may be also similar. However, since different spectral ranges are involved, adaptions may be required. The first image detector 12 may be an detector for the visible spectral range (RGB) and the second image detector 42 may be a time-of-flight (ToF) detector, or vice versa. Preferably, the entrance aperture 32 comprises an antireflection coating configured for transmitting the full spectrum of the imaging light B. In another preferred embodiment, the spectral filtering element 28 comprises a dielectric layer or grating.

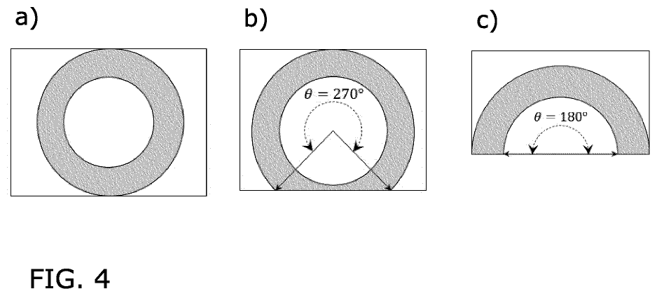

FIG. 4 shows schematic illustrations for using different alignments of the images on the detectors to optimize image resolution and FOV of the imager of a surround-view imaging system. The projection of a scene on a detector can be adjusted to obtain smaller, but higher resolution horizontal/vertical FOV. While in example a) the FOV of the imager is fully imaged on the active surface of the detector, example b) shows an alignment in which the horizontal FOV is slightly reduced to θ=270° at a detector having an active surface of the same size. Under c) another example with a smaller detector and different aspect ratio is shown. On this specific detector the horizontal FOV is even more reduced to θ=180°. However, the full vertical FOV can still be covered by the detector.

### REFERENCE LIST

10 imager
12 first image detector
14 first optical system
20 catadioptric lens
22 first aspheric lens region
24 second aspheric lens region
26 third aspheric lens region
28 spectral filtering element
30 inner volume (corpus)
32 entrance aperture (mantle)
34 top surface
36 bottom surface
42 second image detector
44 second optical system
B imaging light
C1 center (bottom surface 36)
C2 center (top surface 34)
FOV10 field of view of the imager
RGB red, green, blue

1. An imager for a surround-view imaging system, comprising a first image detector and a cylindrical catadioptric lens system forming an inner volume with an entrance aperture, a top surface and a bottom surface; wherein in a field of view of the imager, imaging light from a surrounding of the imager enters the inner volume by the entrance aperture, is firstly reflected towards the top surface by the bottom surface, is secondly reflected back to the bottom surface by the top surface, and leaves the inner volume towards the first image detector by a bottom aperture in the bottom surface for detecting imaging light,
wherein a spectrum of the imaging light comprises a first spectral range and a second spectral range different from the first spectral range, wherein the top surface comprises a spectral filtering element which reflects only the imaging light of the first spectral range back to the bottom surface but transmits the imaging light of the second spectral range.

2. The imager of claim 1, wherein the cylindrical catadioptric lens system is formed by a cylindrically shaped monolithic catadioptric lens having a corpus filling the inner volume, and having a mantle including the entrance aperture, the top surface and the bottom surface.

3. The imager of claim 1, wherein the imaging light is firstly reflected by a circumferential first aspheric lens region arranged around a center of the bottom surface, is secondly reflected by a second aspheric lens region arranged at a center of the top surface, and leaves the inner volume towards the first image detector by a third aspheric lens region at the center of the bottom surface.

4. The imager of claim 1, wherein the imager further comprises a first optical system to project an image of an environment in the first spectral range on the first image detector.

5. The imager of claim 4, further comprising a second image detector for detecting the transmitted imaging light.

6. The imager of claim 5, wherein the imager further comprises a second optical system to project an image of the environment in the second spectral range on the second image detector.

7. The imager of claim 5, wherein the first image detector is a detector for a visible spectral range and the second image detector is a time-of-flight detector, or wherein the first image detector is the time-of-flight detector and the second image detector is a detector for the visible spectral range.

8. The imager of claim 1, wherein the entrance aperture comprises an antireflection coating configured for transmitting a full spectrum of the imaging light.

9. The imager of claim 5, wherein the first image detector and the second image detector are arranged opposite to one another with their active surface parallelly aligned along a vertical axis of the imager.

10. The imager of claim 1, wherein the spectral filtering element comprises a dielectric layer or grating.
